(19) United States
(12) Patent Application Publication
(10) Pub. No.: US 2006/0248476 A1
(43) Pub. Date: Nov. 2, 2006

(54) Printer control program and apparatus

(75) Inventor: Takafumi Yamada, Nagoya-shi (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: Brother Kogyo Kabushiki Kaisha, Nagoya-shi (JP)

(21) Appl. No.: 11/390,351

(22) Filed: Mar. 28, 2006

(30) Foreign Application Priority Data
Mar. 30, 2005 (JP) 2005-099422

(51) Int. Cl. G06F 9/00

(52) U.S. Cl. 715/835; 715/856; 715/862; 715/815

(57) ABSTRACT

A program product for enabling a computer to control operations of a printer. The computer includes a display and a pointing device for controlling a position of a pointer on the display. The program product includes: software instructions for enabling the computer to perform predetermined operations and a computer readable medium bearing the software instructions. The predetermined operations include: displaying a printer icon corresponding to the printer; and enlarging the printer icon so as to include an indication of a function of the printer when an operation of the pointing device causes a print data icon that corresponds to a print data to be moved adjacent to or at a position of the printer icon.

### CROSS-REFERENCE TO RELATED APPLICATIONS

The present disclosure relates to the subject matter contained in Japanese Patent Application No. 2005-099422 filed Mar. 30, 2005, which is incorporated herein by reference in its entirety.

### TECHNICAL FIELD

The present invention relates to a printer control program and a printer control apparatus. Particularly, the invention is effective to be used for control of a printer connected onto a network.

### BACKGROUND

The operations of a printer connected onto a network (hereinafter, referred to as a network printer) and a printer connected directly to a computer without through such network (hereinafter, referred to as a local printer) are controlled usually by a computer system.

The computer system includes a computer including a CPU (Central Processing Unit), a ROM (Read-Only Semiconductive Memory), a RAM (Random-Access Memory), and an HDD (Hard Disk Drive); a display part such as a display; an input operation part such as a keyboard; and a pointing device such as a mouse and a track pad.

In a computer system having a graphical user interface (hereinafter written as GUI) function, a user (human being) operates a pointing device thereby to overlay a print data meaning icon displayed on a display (hereinafter referred to as a print data icon) is overlaid on a printer meaning icon (hereinafter referred to as a printer icon) displayed on the display. Hereby, print data corresponding to its print data icon can be printed by a printer corresponding to its printer icon (refer to, for example, JP-A-2001-337765).

The GUI is a method of inputting an instruction (command) for operating the computer system in the computer system: When the user operates the computer system, the instruction (command) is inputted by selecting the specified portion on the display with a pointer that is movable on the display according to the operation of the pointing device. The icon represents contents or an object of processing (command) with a small picture or a symbol.

In the vicinity of a printer icon (normally, just under a printer icon), a name of printer (hereinafter, referred to as a printer name) that its printer icon represents may be displayed.

Assuming that plural network printers exit on a network, when the user intends to print the print data by the predetermined network printer, the user must specify (judge) the network printer that he or she desires to operate, based on the printer name. Further the user must operate the pointing device so that a printer icon indicating the predetermined network printer and the print data icon are superimposed onto each other on the display.

However, the printer name usually is given such as “Printer 1” or “Printer 2”, which does not have something to do with the location where the printer is set. Therefore, it is difficult for the user to specify from the printer name the network printer which he desires to actuate. There is a strong likelihood in selecting the printer icon that the user cannot discriminate which printer icon is to be selected. As such, usablity of the printer may be lowered.

The invention, in view of the above problem, has an object to enable the user to readily discriminate which printer icon is to be selected when he selects a printer icon.

### SUMMARY

The invention may provide a program product for enabling a computer to control operations of a printer, wherein the computer includes a display and a pointing device for controlling a position of a pointer on the display, the program product including: software instructions for enabling the computer to perform predetermined operations; and a computer readable medium bearing the software instructions. The predetermined operations include: displaying a printer icon corresponding to the printer; and enlarging a size of the printer icon so as to include an indication of a function of the printer when an operation of the pointing device causes a print data icon that corresponds to a print data to be moved either adjacent to or at a position of the printer icon.

The invention may provide a printer control apparatus for controlling a printer, including: a display; a pointing device that controls a position of a pointer on the display; a printer icon display unit configured to display a printer icon corresponding to the printer; and a printer icon enlarge unit configured to enlarge a size of the printer icon so as to include an indication of a function of the printer when an operation of the pointing device causes a print data icon that corresponds to a print data to be moved either adjacent to or at a position of the printer icon.

### BRIEF DESCRIPTION OF THE DRAWINGS

The present invention may be more readily described with reference to the accompanying drawings:

FIG. 1 is a block diagram showing an outline of a network including a printer control apparatus according to an illustrative aspect of the invention, a server device, and a printer.

FIGS. 2A-2C are schematic views showing examples of a display screen of the printer control apparatus.

FIGS. 3A and 3B are schematic views showing examples of a display screen of the printer control apparatus.

FIG. 4 is a schematic view showing an example of a display screen of the printer control apparatus.

FIG. 5 a flowchart showing an outline of a printer control program according to the illustrative aspect.

FIG. 6 is a flowchart showing an outline of printer status monitoring control according to the illustrative aspect.

FIG. 7 is a table showing error information in the illustrative aspect.

FIG. 8 is a flowchart showing an outline of printer information acquirement control according to the illustrative aspect.

FIG. 9 is a table showing printer information in the illustrative aspect.

FIG. 10 is a flowchart showing an outline of printer setting control according to the illustrative aspect.

FIG. 11 is a schematic view showing an example of a display screen of the printer control apparatus.

### DESCRIPTION OF ILLUSTRATIVE ASPECTS

An illustrative aspect of the invention will be described below with reference to drawings.

In the illustrative aspect, a printer control program and a printer control apparatus according to the invention are applied to control of a network printer. Namely, in the illustrative aspect, by installing the printer control program according to the invention to a computer system, the computer system is operated as a printer control apparatus.

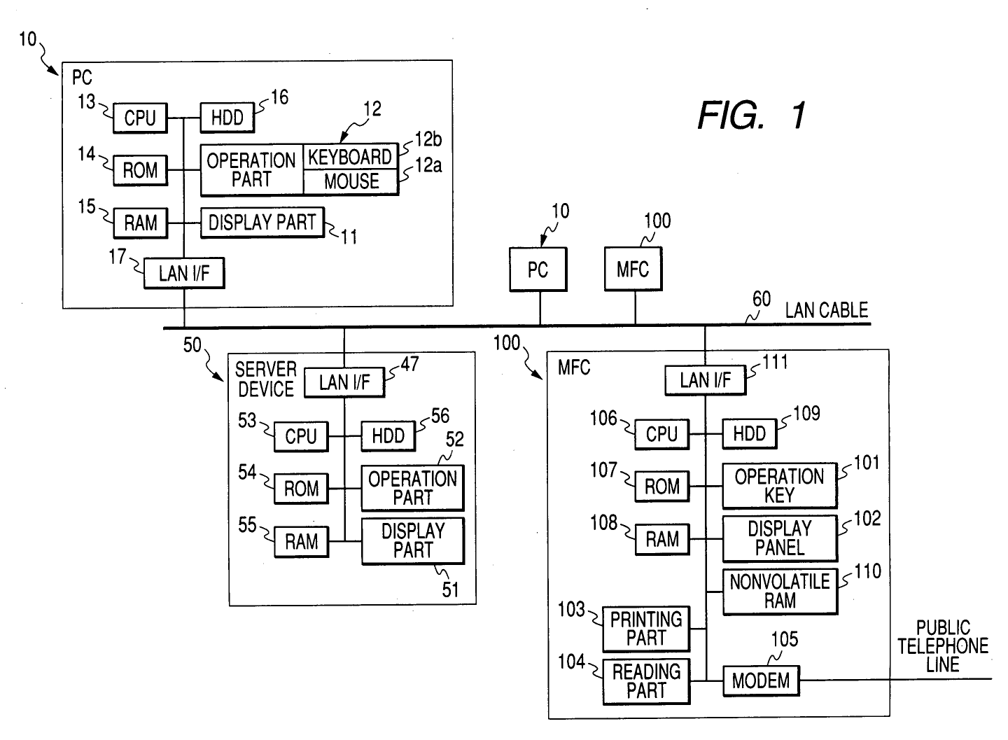

FIG. 1 is a block diagram showing an outline of a network including a printer control apparatus (computer system) 10 according to the illustrative aspect, a server device 50 and a printer 100. Referring to FIG. 1, an outline of the configuration of the printer control apparatus 10 will be described below.

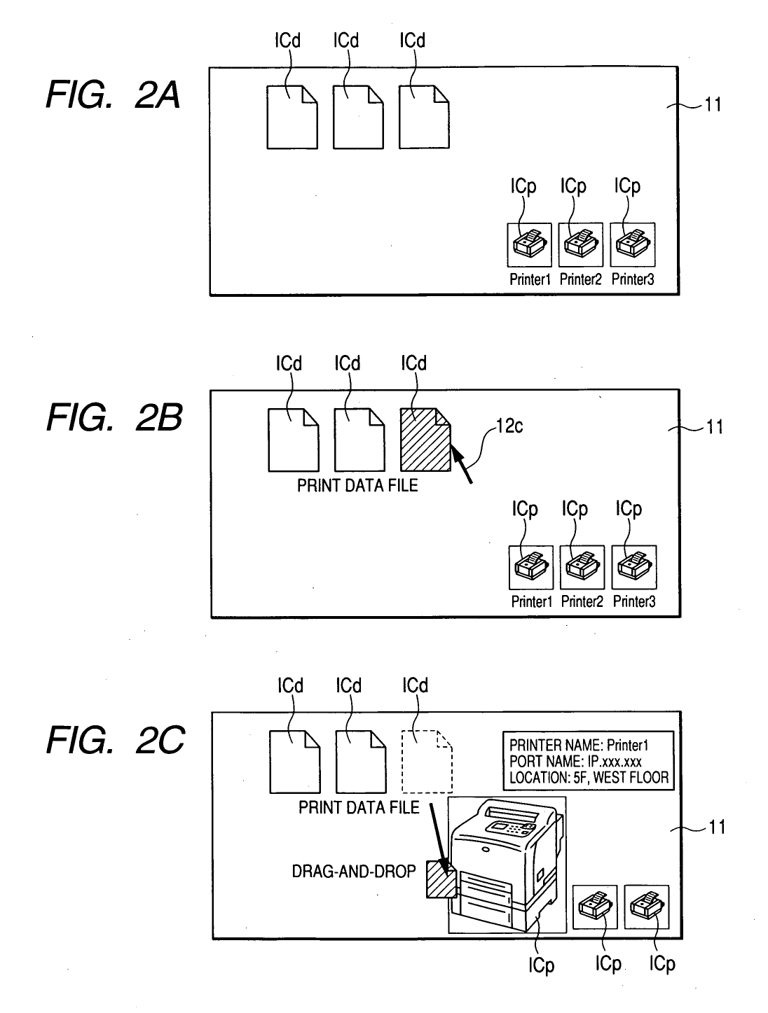

The configuration of the printer control apparatus 10 is similar to that of the known computer system. Specifically, the printer control apparatus (computer system) 10 includes a display part 11 composed of LCD or CRT, which displays an image and a character; an operation part 12 including a mouse 12a and a keyboard 12b, which forms a pointing unit for moving a pointer 12c (refer to FIG. 2B) that points a predetermined portion on the display part 11; a central processing unit (CPU) 13; a read-only semiconductive memory (ROM) 14; a randomly readable/writable semiconductive memory (RAM) 15; a magnetic memory (HDD) 16; and a network interface 17 (LAN I/F) which connects the printer control apparatus (computer system) 10 to a network. Hereinafter, the printer control apparatus (computer system) is written to as a PC 10.

Further, the printer 100 according to the illustrative aspect is a multifunction printer having, in addition to a printer function (printing function), a so-called facsimile function, and a scanner function of reading a character and an image that have been recorded on paper and computerizing the read information.

The printer 100 according to the illustrative aspect (hereinafter written to as a MFC 100) includes an operation key 101 for selecting functions provided in the MFC 100; a display panel 102 which displays operation contents and work status; a printing part 103 which prints a character and an image on a recording medium such as paper; a reading part 104 which reads the character and the image recorded on the paper, and converts the read information into digital data; a modem 105 which has a function of converting the digital data into an audio signal for facsimile communication and transmitting its audio signal to a public telephone line and a function of converting the facsimile audio signal transmitted through the public telephone line into digital signal; a central processing unit (CPU) 106; a read-only semiconductive memory (ROM) 107; a randomly readable/writable semiconductive memory (RAM) 108; a magnetic memory (HDD) 109; a randomly readable/writable semiconductive memory (nonvolatile RAM) 110 which can keep the stored contents even in case that supply of electric power is stopped; and a network interface (LAN I/F) 111 which connects the MFC 100 to the network.

The server device 50 is a computer system having the same configuration as those of the PC 10. This server device gives service of providing shared data (shared resource) to the PC 10 connected onto the network through a LAN cable 60.

Specifically, the server device 50 includes a display part 51 including an LCD or a CRT, which displays an image and a character; an operation part 52 including a mouse 12a and the like that configures a pointing unit for controlling a movement of a pointer for indicating a specified portion on the display part 51; a central processing unit (CPU) 53; a read-only semiconductive memory (ROM) 54; a randomly readable/writable semiconductive memory (RAM) 55; a magnetic memory (HDD) 56; and a network interface 57 (LAN I/F) which connects the server device 50 to the network.

Next, the user's operation with respect to the PC 10 when the user uses the MFC 100 to print the predetermined print data will be described with reference to FIGS. 2A-C. The explanation will be done below with respect to an example in which Windows® having the GUI function is used as an OS (Operating System) of the PC 10.

FIG. 2A shows an example of display contents on the display part 11. In the GUI having the Windows®, normally, as shown in FIG. 2A, in a display area referred to as a “desktop” or a “window”, an icon representing the MFC 100 (hereinafter, written as a printer icon ICp) and an icon representing print data (hereinafter, written as a print data ion ICd) are displayed.

The printer icon ICp normally is designed in such a configuration (shape) that the user can image a general printer, while the print data icon ICd is designed normally in such a configuration (shape) that the user can image a document.

Further, in the vicinity of the printer icon ICp (just under the printer icon in the illustrative aspect), a name of the printer (MFC 100) that the printer icon ICp represents, such as “Printer 1” or “Printer 2”, is displayed.

When the printer icon ICp and the print data icon ICd are displayed on the desktop or the window of the display part 11, the user operates the mouse 12a and places the pointer 12c over, for example, the print data icon ICd as shown in FIG. 2B. While the user keeps its state, the user clicks a selection button (not shown) provided on the mouse 12a thereby to select the print data icon ICd over which the pointer 12c is placed. In this connection, the selection button is arranged normally on the left side of the mouse 12a.

When the selection button is clicked, an illustration color of the selected print data icon ICd changes. Therefore, when the print data icon ICd of which the illustration color has changed is different from the print data icon ICd which the user desires, the user releases the click of the selection button, moves again the pointer 12c on his desire's printer data icon ICd, and thereafter clicks the selection button.

When the user operates the mouse 12a in a state where he keeps clicking the selection button, the selected print data icon ICd moves together with the pointer 12c on the display part 11. Next, the user moves the selected print data icon ICd to a printer icon ICp representing a MFC 100 of his desire, and overlays the print data icon ICd on the printer icon ICp on the display part 11.

At this time, in the state where the selection button keeps clicked, when the print data icon ICd and the printer icon ICp are overlaid on each other, as shown in FIG. 2C, the printer icon ICp is enlarged-displayed. In the vicinity of the enlarged icon, a name of the MFC 100 indicated by the printer icon ICp, a name of port to which the MFC 100 indicated by the printer icon ICp is connected, and a location in which the MFC 100 indicated by the printer icon ICp is actually set (for example, 5F, West floor) are displayed.

Further, when the printer icon ICP is enlarged-displayed, the configuration of the displayed icon, that is, the icon design becomes a configuration (design) indicating the actual functions of the MFC 100 corresponding to the printer icon ICp. The image data for the respective printer icon ICp used for the enlarged display is prepared for each printer (the MFC 100). The image data of the printer icon ICp is stored in a predetermined area in the RAM 15 or in the HDD 16, in association with the corresponding printer name. The storage of the image data may be done at the time of installing a printer driver for the MFC 100 in the PC 10. The image data of the printer icon ICp may be previously stored in the ROM 107 in the printer main frame (the MFC 100). Then the PC 10 may request and obtain the image data of the printer icon ICp from the MFC 100, when a communication between the MFC 100 and the PC is established.

Specifically, when the actual MFC 100 is provided with plural kinds of paper feed trays each accommodating the recording paper, the display configuration of the enlarge-displayed printer icon ICp becomes such a display configuration that the user can visually recognize that the plural kinds of paper supply trays.

Similarly, for example, when in case that plural kinds of paper discharge trays onto which the printed recording paper are discharged are provided, the display configuration of the enlarge-displayed printer icon ICp becomes such display configuration that the user can visually recognize that the plural kinds of paper discharge trays are provided.

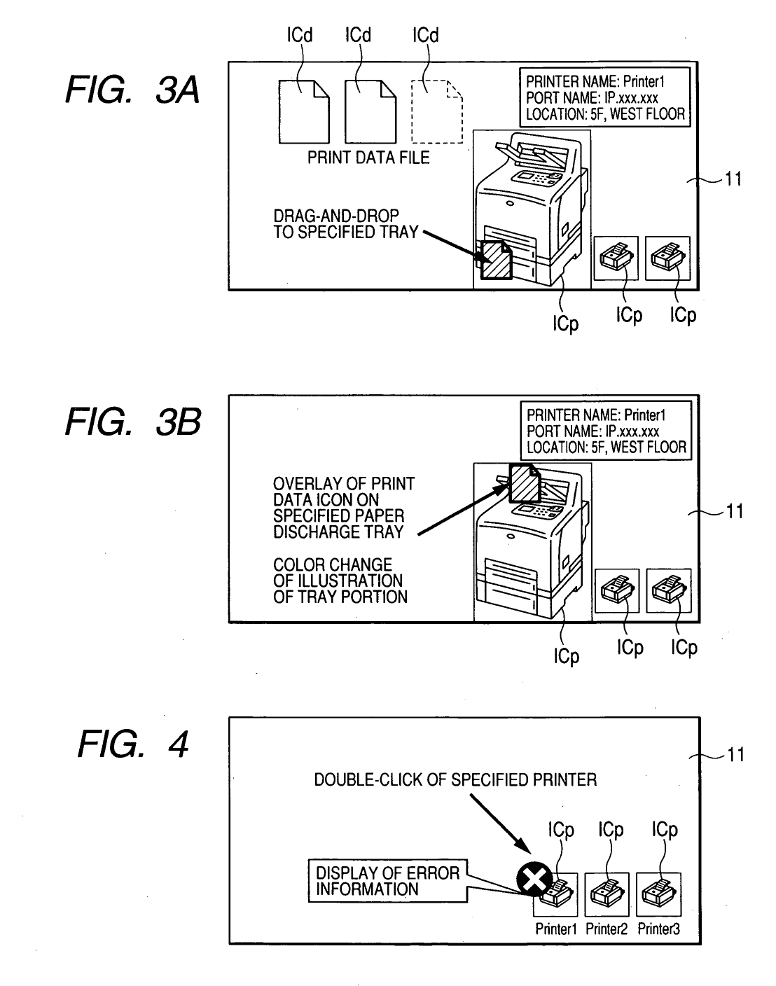

Next, in the state where the selection button keeps clicked, as the print data icon ICd is overlaid on a portion in the printer icon ICP where a function of the MFC 100 is displayed. Then, as shown in FIGS. 3A and 3B, an illustration color of the portion where its function has been displayed changes, and the function (option) that the portion indicates is selected.

Specifically, for example, assume that the actual MFC 100 has an upper paper feed tray and a lower paper feed tray, the print data icon ICd may be overlaid on the portion corresponding to the lower paper feed tray in the enlarged printer icon ICp in the state where the selection button keeps clicked, as shown in FIG. 3A. Then, the lower paper feed tray is selected.

Further, for example, assume that the actual MFC 100 includes a front paper catch tray and a back paper catch tray, the print data icon ICd may be overlaid on the portion corresponding to the front paper catch tray in the enlarged printer icon ICp in the state where the selection button keeps clicked, as shown in FIG. 3B. Then, the front-sided paper discharge tray is selected.

As the selection button is released in the state where the print data icon ICd is overlaid on the printer icon ICp, the actual print data related with the print data ion ICd is printed in accordance with the functions currently selected. The selected functions are the optional functions of performing printing on the recording paper housed on the lower paper feed tray, of discharging the recording paper on which printing has been performed from the front paper catch tray, and the like.

In this connection, in the illustrative aspect, when the selection button is released in the state where the selected print data icon ICd is not overlaid on the portion of the printer icon ICp where the function of the MFC 100 is displayed, the actual print data related with the print data icon ICd is printed in standard option setting. However, the invention is not limited to this. For example, in the option setting set in the last printing time, printing may be performed.

Further, in case that the MFC 100 is in a unprintable state because a power supply of the MFC 100 is shut off, or any trouble is produced in connection through the network, the purport of “the MFC 100 cannot be used at the present” is displayed in the printer icon ICp corresponding to the actual MFC 100, as shown in FIG. 4. Further, in case that the print data icon ICd is overlaid on the printer icon ICp representing the MFC 100 in which the trouble is produced, the printer icon ICp is not enlarged-displayed, and the option setting cannot be performed.

Further, in case that he print data icon ICd is overlaid on the printer icon ICp in which the purport of “the MFC 100 cannot be used at the present” is displayed, or in case that the printer icon ICp in which the purport of “the MFC 100 cannot be used at the present” is displayed is selected by the pointer 12c, a cause (error information) why the MFC 100 corresponding to the selected printer ion ICp cannot perform printing is displayed.

Next, a printer control program for realizing the above printing operation and function will be described.

The printer control program according to the illustrative aspect is installed into each PC 10 connected to a network to which the target MFC 100 is connected, thereby to operate the PC 10 into which the program has been installed, as a printer control apparatus.

The installed printer control program is stored in the magnetic memory (HDD) 16 or 56 of the PC 10 or the server device 50, read according to necessity from the magnetic memory (HDD) 16 and 56 into the randomly readable/writable semiconductive memories (RAM's) 15 and 54, and controls the operation of the MFC 100 in cooperation with the OS.

1. Outline of Whole of Printer Control Program

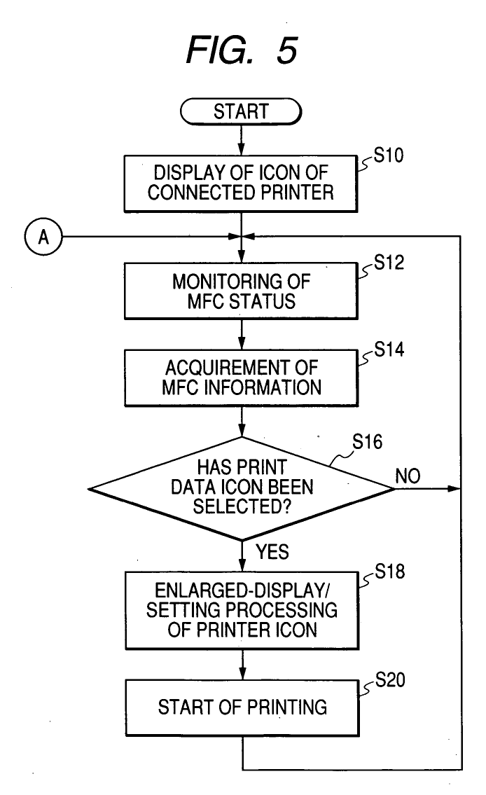

FIG. 5 is a flowchart showing an outline of the whole of a printer control program. After this printer control program has been normally installed into the PC 10, it is automatically started simultaneously with starting of the OS, and it ends simultaneously with shut-down of the OS.

As the OS is started and this printer control program is started, firstly, a printer icon ICp which means a MFC 100 connected directly to a network, or a usable MFC 100 or printer (hereinafter, a MFC 100 and a printer are generically written as a MFC 100) such as a printer connected indirectly to the network through the PC 10 connected to the network is displayed on the display part 11 (desktop or window) (S10).

Next, after the status of the MFC 100 corresponding to the printer icon ICp displayed on the display part has been monitored (S12), information of the MFC 100 is acquired (S14). Here, the status of the MFC 100 represents whether the MFC 100 is put in a normally operatable state as a printer or not, for example, whether the MFC 100 cannot execute the printing operation because there is no recording paper or the recording paper is jammed. The details of the state of the MFC 100 will be described later.

Further, the information of the MFC 100 includes a name, a port name and a setting location of the MFC corresponding to the printer icon ICp. These information, normally, when the MFC 100 is connected to the network, are input/set in the MFC 100 manually or automatically, and stored in the nonvolatile RAM 110. The acquirement of the MFC 100 information will be described later in detail.

Next, whether a print data icon ICd has been selected in cooperation with the OS is judged, that is, whether the selection button has been clicked in a state where the print data icon ICd and the pointer 12c are overlaid on each other on the display part 11 is judged (S16). In case that it is judged that the print data icon ICd has not been selected (S16: NO), the printer control program returns to the step S12.

On the other hand, in case that it is judged that the print data icon ICd has been selected (s16: YES), a processing program for operating functions such as enlargement-display of the printer icon ICp and setting location display of the MFC 100 (hereinafter, this processing is mentioned as printer icon enlargement-display/setting processing is started (S18). The details of the printer icon enlargement-display/setting processing will be described later.

Upon completion of the printer icon enlargement-display/setting processing, print processing of the print data related with the print data icon ICd is started (S20). After completion of the print processing, the program returns to the step S12 again.

2. Printer Status Monitoring Control

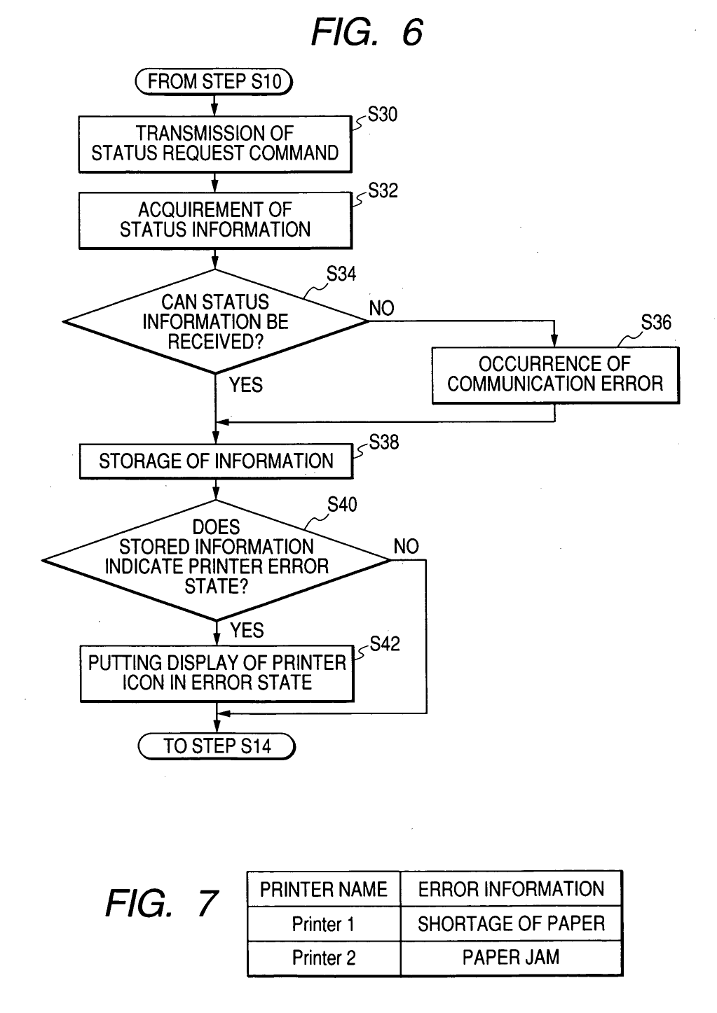

FIG. 6 is a flowchart showing an outline of printer status monitoring control (S12). As the printer status monitoring control is started, a command (status requiring command) for returning information indicating the status of the MFC 100 to the PC is given from the PC 10 to the MFC 100 (S30). Thereafter, the information (status information) indicating the status of the MFC 100 is acquired (S32), and its information is stored in the RAM 17 of the PC 10 (S38).

At this time, in case that the status information cannot be received because the power source is shut off (S34: NO), information indicating that communication error is produced is stored as the status information (S36, S38).

Next, whether the stored information is information indicating the error of the MFC 100 or not is judged (S40). In case that it is judged that the stored information is the information indicating the error of the MFC 100 (S40: YES), a printer icon corresponding to the MFC 100 judged to be erroneous is put in the error state (S42). Thereafter, the printer status monitoring control (S12) ends, and a step S14 (refer to FIG. 5) is executed.

To put the printer icon ICp in the error state means: to change the display configuration of its printer icon ICp thereby to perform indicating that “the MFC 100 corresponding to the printer icon ICp cannot be used at the present”, and to display, if the print data icon ICd is overlaid on its printer icon ICp, or if its printer icon ICp is selected by the pointer 12c, a cause (error information) by which the MFC corresponding to its printer icon ICp cannot perform printing.

In the connection, as the displayed error information, there are “shortage of paper” and “paper jam” as shown in FIG. 7, or communication error.

Further, in case that it is judged that the stored information is not the information indicating the error of the MFC 100 (S40: NO), the display of the printer icon ICp is not put in the error state, but the printer status monitoring control (S12) ends and a step S14 (refer to FIG. 5) is executed.

3. Printer Information Acquirement Control

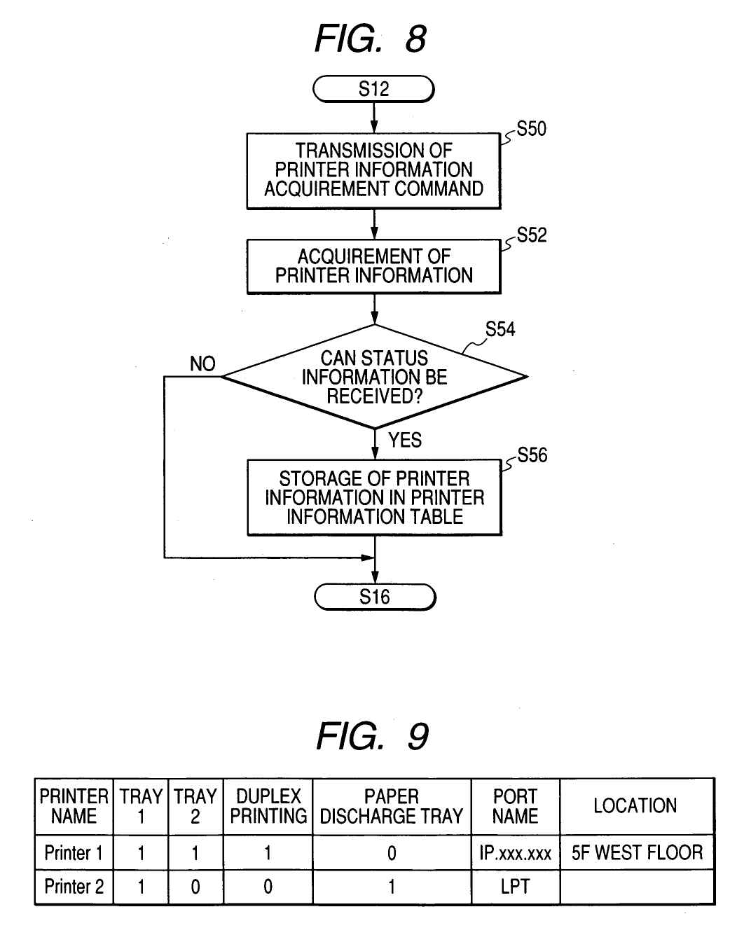

FIG. 8 is a flowchart showing an outline of printer information acquirement control (S14). As the printer information acquirement control flow is started, a command (printer information acquiring command) for returning the printer information stored in the MFC 100 to the PC is given from the PC 10 to the MFC 100 (S50). Thereafter, the printer information of the MFC 100 is acquired (S52), its printer information is stored in the RAM 17 of the PC 10 (S56), the printer information acquirement control ends, and a step S16 (refer to FIG. 5) is executed.

On the other hand, at this time, in case that the status information cannot be received because the power source is shut off (S54: NO), the printer information is not stored in the RAM 17 of the PC 10, but the printer information acquirement control ends and the step S16 (refer to FIG. 5) is executed.

The printer information acquired by the printer information acquirement control includes, as shown in FIG. 9, a printer name, the number of paper supply trays, whether duplex printing is possible or not, presence or absence of a paper discharge tray, a connection port name of MFC 100, and a setting location of MFC 100.

In the connection, in FIG. 9, in case that a tray 2 is 1, this case means that the tray 2 can be selected as a function (option) of the MFC 100. To the contrary, in case that the tray 2 is 0, this case means that the tray 2 cannot be selected as a function (option) of the MFC 100.

Similarly, in case that duplex printing is 1, this case means that duplex printing is possible as a function (option) of the MFC 100. To the contrary, in case that duplex printing is 0, this case means that duplex printing is impossible as a function (option) of the MFC 100.

4. Printer Setting Control (Printer Icon Enlarged-Display/Setting Processing)

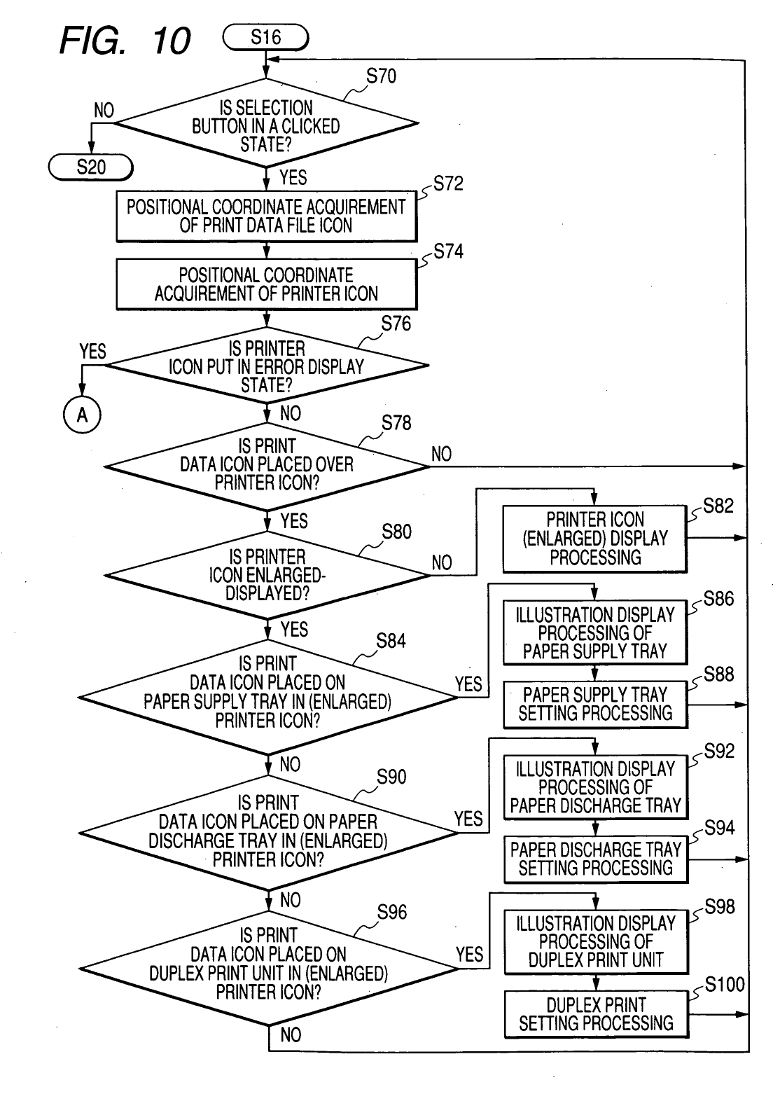

FIG. 10 is a flowchart showing an outline of printer icon enlarged-display/setting processing (S18). As the printer icon enlarged-display/setting processing is started, firstly, whether the selection button of the mouse 12a is clicked or not is judged (S70). The reasons why whether the selection button of the mouse 12a is clicked or not is judged are the following two points:

Namely, the printer icon enlarged-display/setting processing (S18) is started when the print data icon ICd is selected, that is, when the selection button is clicked in the state where the print data icon ICd and the pointer 12c are overlaid on each other. However, the user, in order to read or edit contents of the data corresponding to the print data icon ICd, can select the print data icon ICd.

In case that the user, in order to read or edit contents of the data corresponding to the print data icon ICd, selects the print data icon ICd, after the data corresponding to the print data icon ICd has been opened by the predetermined application, click of the selection button is released and the selection button does not keep clicked.

Therefore, in the illustrative aspect, when the printer icon enlarged-display/setting processing is started, firstly, whether the selection button of the mouse 12a is clicked or not is judged, whereby whether the user, in order to read or edit contents of the data corresponding to the print data icon ICd, selects the print data icon ICd, or the user, in order to print the data corresponding to the print data icon ICd, that is, in order to overlay the print data icon ICd and the printer icon ICp on each other, selects the print data icon ICd is judged.

Further, as described later, in the printer icon enlarged-display/setting processing, by overlaying the print data icon ICd on the specified portion of the enlarged-displayed printer icon IC, the user can set the function that its portion means. Therefore, in order to judge whether the option setting operation has ended or not, whether the selection button of the mouse 12a is clicked or not is judged.

Namely, in the illustrative aspect, it is judged that the option setting operation has not ended in the state where the selection button is clicked. After the printer icon ICp has been enlarged-displayed, when click of the selection button is released, it is judged that the option setting operation has ended, so that the printer icon enlarged-display/setting processing ends, and the next print processing (S20) is executed.

In case that it is judged that the selection button of the mouse 12a is clicked in the step S70 (S70: YES), it is thought that the user intends to print the contents of the data corresponding to the print data icon ICd. Therefore, the printer icon enlarged-display/setting processing in the step S72 and later is executed.

Namely, in cooperation with the OS, a position coordinate of the print data icon ICd and a position coordinate of the printer icon ICp are acquired (S72, S74). Next, whether the printer icon ICp is put in the error display state or not, that is, whether the printer icon ICp is judged to be in the error state in the step S40 of the printer status monitoring control (S12) or not is judged (S76). In case that it is judged that the printer icon ICp is in the error state (S76: YES), the printer icon enlarged-display/setting processing ends its processing and the control program returns to the printer status monitoring control (S12).

Thus, in case that it is judged that the printer icon ICp is in the error state (S76: YES), the sequential control steps are not executed. Therefore, as long as the error state of the printer icon ICp is released, the enlarged-display function or the option setting function of the printer icon ICp do not operate.

Further, in case that it is judged that the printer icon ICp is not in the error state (S76: NO), on the basis of the position coordinate of the print data icon ICd acquired in the step S72 and the position coordinate of the printer icon ICp acquired in the step S74, whether the print data icon ICd and the printer icon ICp are overlaid on each other on the display part 11 or not is judged (S78). In case that it is judged that the print data icon ICd and the printer icon ICp are not overlaid on each other on the display part 11 (S78: NO), the printer icon enlarged-display/setting processing returns to the step S70.

On the other hand, in case that it is judged that the print data icon ICd and the printer icon ICp are overlaid on each other on the display part 11 (S78: YES), whether the printer icon that is being displayed on the display part 11 is the enlarged-displayed printer icon ICp (refer to FIG. 2C) or the normally displayed (size-reduced) printer icon ICp (refer to FIG. 2A) is judged (S80).

In case that it is judged that the printer icon ICp displayed on the display part 11 is the normally displayed (size-reduced) printer icon ICp (S80: NO), the normally displayed printer icon ICp is enlarged so as to have the display configuration (design) in which the actual functions of the MFC 100 corresponding to the printer icon ICp are displayed. Further, in the vicinity of the enlarged printer icon ICp, a name of port to which the MFC 100 corresponding to the printer icon ICp is connected, and a location (for example, 5F, west floor) where the MFC 100 corresponding to the printer icon ICp is actually set are displayed (S82). Thereafter, the printer icon enlarged-display/setting processing is returned to the step S70.

In addition, the data for the printer icon ICp used for the enlarged display is previously stored in the PC, as explained above. When it is judged that the normally-displayed printer icon ICp and the print data icon ICp are superimposed, it is judged which of the MFCs 100 corresponds to the printer icon ICp. Then the image data of the printer icon ICp for an enlarged display, which is stored in association with the name of the MFC 100, is read and displayed on the display part 11.

Further, when there is any change in the printer information that is acquired in S14, the icon data is modified so that the icon data corresponding to the latest printer information is displayed. Taking an example as shown in FIG. 9, the “Printer 2” is originally provided with the paper feed tray 2, which is later detached and become unavailable. In such a case, the printer information is set “0” with respect to the paper feed tray 2. When the “Printer 2” is selected, the icon data is modified based on the previously-stored data of the printer icon ICp for the enlarged-display, so that the paper feed tray 2 cannot be selected. Specifically, such a modification may be done by deleting the portion corresponding to the paper feed tray 2, or by adding a mark at the portion of the paper feed tray 2 to indicate that the paper feed tray is not available.

Similarly, when “Printer 1” is selected and “0” is stored as the printer information with respect to the paper discharge tray, the printer icon ICp is displayed so that the paper discharge tray is omitted. In such a case, the printer icon ICp for “Printer 1” is displayed in an enlarged manner as shown in FIG. 2C so that the paper discharge tray is omitted, while the enlarged printer icon ICp for “Printer 1” as shown in FIG. 3A is displayed so that the paper discharge tray is added to the printer mainframe.

The icon data for expressing the printer in which the tray is omitted, and the printer with a mark indicating that a portion is not selectable are also obtained at the time of installing the printer driver. Various patterns of icon data may be prepared correspondingly to types of the functions that are provided in the respective printers (the MFCs 10).

In case that it is judged that the printer icon ICp being currently displayed is the enlarged-displayed printer icon ICp (S80: YES), whether the printer data icon ICd is overlaid on a portion corresponding to any paper supply tray in the enlarged printer icon ICp or not is judged (S84).

In case that it is judged that the print data icon ICd is overlaid on the portion corresponding to any paper supply tray in the enlarged printer icon ICp (S84: YES), the illustration color of the portion on which the print data icon ICd is overlaid is changed (S86), and the information indicating that the paper supply tray of which the illustration color is changed is selected (set) is stored on the memories such as the RAM's 15 and 55 (S88). Thereafter, the printer icon enlarged-display/setting processing is returned to the step S70.

On the other hand, in case that it is judged that the print data icon ICd is not overlaid on the portion corresponding to any paper supply tray in the enlarged printer icon ICp (S84: NO), whether the print data icon ICd is overlaid on a portion corresponding to any paper discharge tray in the enlarged printer icon ICp or not is judged (S90).

In case that it is judged that the print data icon ICd is overlaid on the portion corresponding to any paper discharge tray in the enlarged printer icon ICp (S90: YES), the illustration color of the portion on which the print data icon ICd is overlaid is changed (S92), and the information indicating that the paper discharge tray of which the illustration color is changed is selected (set) is stored on the memories such as the RAM's 15 and 55 (S94). Thereafter, the printer icon enlarged-display/setting processing is returned to the step S70.

On the other hand, in case that it is judged that the print data icon ICd is not overlaid on the portion corresponding to any paper discharge tray in the enlarged printer icon ICp (S90: NO), whether the print data icon ICd is overlaid on a portion corresponding to a duplex print unit in the enlarged printer icon ICp or not is judged (S96).

In case that it is judged that the print data icon ICd is overlaid on the portion corresponding to the duplex print unit in the enlarged printer icon ICp (S96: YES), the illustration color of the portion on which the print data icon ICd is overlaid is changed (S98), and the information indicating that the duplex printing is selected (set) is stored on the memories such as the RAM's 15 and 55 (S100). Thereafter, the printer icon enlarged-display/setting processing is returned to the step S70.

Further, also in case that it is judged that the printer data icon ICd is not overlaid on the portion corresponding to the duplex print unit in the enlarged printer icon ICp (S96: NO), the printer icon enlarged-display/setting processing is returned to the step S70.

As such, this illustrative aspect is configured to select (set) one of the functions provided in the MFC 100 such as the paper feeding tray 2 and the paper catch tray, by overlaying the print data icon ICd on the portion of the enlarged printer icon ICp tray corresponding to the paper feeding tray 2 or the paper catch tray. It may be preferable to set the size of the paper feed tray 2 and the paper catch tray in the enlarged printer icon ICp to be similar to, or larger than the size of the print data icon ICd.

As clear from the above description, in this illustrative aspect, in the step S82, the PC 10 functions as the printer icon display unit, the printer icon enlarge unit, the printer information display unit, and the icon changing unit. Further, in the steps S84 to S90, the PC functions as the option function setting unit; in the step S12, the PC 10 functions as the monitoring unit; in the step S42, the PC 10 functions as the print-impossibility display unit; and in the step S76, the PC 10 functions as the enlargement disabling unit.

Next, the features of the printer control program and the printer control apparatus according to the invention will be described.

In the illustrative aspect, in case that the print data icon ICd and the printer icon ICp are overlaid on each other on the display part 11, in the vicinity of the printer icon ICp, at least a name of MFC 100 (printer name) and a setting location of its MFC 100 are displayed. Therefore, when the user selects any printer icon ICp, he can readily judge which printer icon ICp he should select. Accordingly, the convenience of using the MFC 100 (printer) can be improved.

Further, since the display configuration (design) of the printer icon ICp becomes the display configuration (design) in which the functions of the actual MFC 100 that its printer icon ICp means are displayed, the user can readily image the actual MFC 100.

Therefore, since the user can more readily judge which printer icon ICp he should select, the convenience of using the printer can be improved.

Further, when the printer icon ICp and the print data icon ICd are overlaid on each other, the printer icon ICp is enlarged-displayed. Therefore, the user can visually recognize the display configuration of the printer icon ICp readily.

Besides the display configuration (design) of the printer icon ICp is made so as to display the actual functions of the MFC 100 indicated by the printer icon ICp, the user can easily discriminate which printer icon ICp should be selected. Accordingly, the useablity of the MFC 100 (printer) can be further improved.

Further, by overlaying the print data icon ICd on the portion corresponding to the paper supply tray or the paper discharge tray in the printer icon ICp, the function (option) corresponding to the portion can be selected (set). Accordingly, the option can be easily selected.

Thus, the plentiful options of the MFC 100 can be readily selected, improving the useability of the MFC 100 (printer).

Further, when the MFC 100 (printer) is unavailable, such unavailability is displayed. Accordingly, an inadvertent selection of a predetermined MFC 100 by the user may be avoided even when the user does not know such unavailability of the predetermined MFC 100.

Further, even when the user overlays the print data icon ICd onto the printer icon ICp by missing the indication of the MFC 100 (printer) being in the unusable state, the printer icon ICp is not enlarged. Then, the user can surely recognize that a failure occurs in the MFC 100 (printer) corresponding to the printer icon ICp that he selects. Thus, it is possible to prevent the user from giving a print command to the PC 10 without knowing that the predetermined MFC 100 is in the unusable state.

Further, in the above illustrative aspect, when the printer icon ICp is enlarged, the setting location of the MFC 100 corresponding to the printer icon ICp is displayed. Accordingly, the user can select an appropriate printer taking the locations of printers into consideration.

Further, in the above illustrative aspect, colors of portions of the printer icon ICp corresponding to the functions of the MFC 100 may be changed. Accordingly, the user can easily recognize at sight which of the functions is set.

(Other Illustrative Aspect)

In the above illustrative aspect, the display configuration (design) of the printer icon ICp is made so as to display the actual functions of the MFC 100 indicated by the printer icon ICp. The display configuration of the printer icon ICp may be modified or emphasized to the extent that the user can recognize the functions of the printer from the actual appearance of the printer icon ICp.

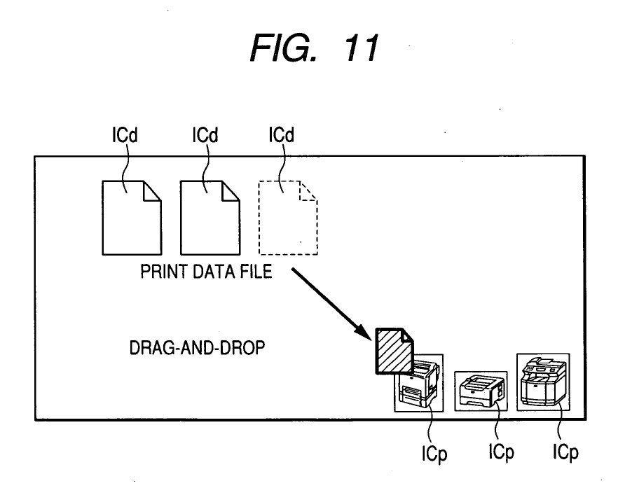

In the above illustrative aspect, a common printer icon ICp is used in a normal state for the respective printers. When the printer icon ICp is enlarged, the configuration of the printer icon ICp is made to indicate the actual functions of the MFC 100 corresponding to the selected printer icon ICp. However, the invention is not limited to this. Also in the normal state, the configuration of the printer icon ICp may include an indication of the actual functions of the MFC 100 corresponding to the printer icon ICp, as shown in FIG. 11. With the printer icon ICp having such configuration, the user can easily discriminate which printer icon should be selected.

Additionally, in the above illustrative aspect, when the printer icon ICp is enlarged, the display configuration of the printer icon ICp includes the actual functions of the MFC 100 indicated by the selected printer icon ICp for the following reason: In the normal display, the printer icon ICp is reduced in size. When the printer icon ICp is reduced in size, the configuration of the printer icon ICp including the actual functions of the corresponding MFC 100 may not be understandable.

Further, in the above illustrative aspect, the explanation has been done with respect to the printer in which the paper supply tray and the paper discharge tray are selectable. However, the invention is not limited to such printer.

Further, in the above illustrative aspect, as examples of the optional functions, the selection of paper supply tray, the selection of paper discharge tray, and the presence or absence of duplex printing function have been described. However, the optional functions are not limited to only these examples.

Further, in the above illustrative aspect, with the network printer as an example, the illustrative aspect of the invention has been described. However, application of the invention is not limited such the printer, but the invention can be applied also to the local printer.

Further, in the above illustrative aspect, the printer control program according to the invention is installed in the versatile computer system, whereby the printer control apparatus according to the invention is configured. However, the invention is not limited to this. For example, the printer control apparatus according to the invention may be configured by a dedicated computer system including a dedicated hardware which acts similarly to the printer control program.

Further, in the above illustrative aspect, during the printer icon enlarged-display/setting processing (S18), the selection button always must keep clicked. However, the invention is not limited to this. For example, the selection button may be clicked only when each option is selected.

Further, in the above illustrative aspect, since the printer information is stored on each MFC 100 (printer), its information is acquired each time. However, the invention is not limited to this. For example, when the MFC 100 (printer) and the driver thereof are installed, the printer information may be stored in the PC 10.

While the invention has been described in conjunction with the specific illustrative aspects described above, many equivalent alternatives, modifications and variations may become apparent to those skilled in the art when given this disclosure. Accordingly, the exemplary embodiments of the invention as set forth above are considered to be illustrative and not limiting. Various changes to the described embodiments may be made without departing from the spirit and scope of the invention.

What is claimed is:

1. A program product for enabling a computer to control operations of a printer, wherein the computer includes a display and a pointing device for controlling a position of a pointer on the display, the program product comprising:
software instructions for enabling the computer to perform predetermined operations; and
a computer readable medium bearing the software instructions;
wherein the predetermined operations include:
displaying a printer icon corresponding to the printer; and
enlarging a size of the printer icon so as to include an indication of a function of the printer when an operation of the pointing device causes a print data icon that corresponds to a print data to be moved either adjacent to or at a position of the printer icon.

2. The program product according to claim 1, wherein the enlarging step includes: displaying a name and a location of the printer.

3. The program product according to claim 1, wherein the predetermined operation includes: displaying the printer icon so as to include the indication of the function of the printer when the print data icon is neither adjacent to nor at the position of the printer icon.

4. The program product according to claim 1, wherein the predetermined operations include: setting an optional function of the printer when the print data icon is moved either adjacent to or at a position of a part of the printer icon; and
the part of the printer icon indicates the optional function.

5. The program product according to claim 4,
wherein the enlarging step includes changing a color of the part of the printer icon.

6. The program product according to claim 1,
wherein the function of the printer includes at least one of a selection of a feeding tray, a selection of a catch tray, and a duplex printing.

7. The program product according to claim 1, wherein the predetermined operations include:
monitoring and judging whether the printer is in a printable state; and
displaying an indication of impossibility of print on the display when the printer is judged to be in an unprintable state.

8. The program product according to claim 7, wherein the enlarging step is disabled when the printer is judged to be in an unprintable state.

9. The program product according to claim 9, wherein the predetermined step include:
obtaining a printer information including information as to a function of the printer; and
changing a configuration of the printer icon so as to correspond to the information as to the function of the printer.

10. A printer control apparatus for controlling a printer, comprising:
a display;
a pointing device that controls a position of a pointer on the display;
a printer icon display unit configured to display a printer icon corresponding to the printer; and
a printer icon enlarge unit configured to enlarge a size of the printer icon so as to include an indication of a function of the printer when an operation of the pointing device causes a print data icon that corresponds to a print data to be moved either adjacent to or at a position of the printer icon.

11. The printer control apparatus according to claim 10, further comprising: a printer information display unit configured to display a name and a location of the printer when the printer icon enlarge unit enlarges the printer icon.

12. The printer control apparatus according to claim 10,
wherein the printer icon display unit displays the printer icon so as to include the indication of the function of the printer when the print data icon is neither adjacent to nor at the position of the printer icon.

13. The printer control apparatus according to claim 10, further comprising: an optional function setting unit configured to set an optional function of the printer when the print data icon is moved either adjacent to or at a position of a part of the printer;
wherein the part of the printer icon indicates the optional function.

14. The printer control apparatus according to claim 13,
wherein the printer icon enlarge unit changes a color of the part of the printer icon.

15. The printer control apparatus according to claim 10,
wherein the function of the printer includes at least one of a selection of a feeding tray, a selection of a catch tray, and a duplex printing.

16. The printer control apparatus according to claim 10, further comprising: a monitoring unit configured to monitor and judge whether the printer is in a printable state; and
a print-impossibility display unit configured to display an indication of impossibility of print on the display when the monitoring unit judges that the printer is in an unprintable state.

17. The printer control apparatus according to claim 16,
wherein the printer icon enlarge unit is disabled when the monitoring unit judges that the printer is in a unprintable state.

18. The printer control apparatus according to claim 9, further comprising: a printer information obtaining unit configured to obtain a printer information including information as to a function of the printer; and
an icon changing unit that changes a configuration of the printer icon so as to correspond to the information as to the function of the printer.
